(19) United States
(12) Patent Application Publication
(10) Pub. No.: US 2008/0228620 A1
(43) Pub. Date: Sep. 18, 2008

(54) System And Method For Transfer Of Confirmation Data In A Distributed Electronic Trading System

(76) Inventor: James C. Johnson, Cresskill, NJ (US)

Correspondence Address: BAKER BOTTS L.L.P., 2001 ROSS AVENUE, SUITE 600, DALLAS, TX, 75201-2980, US

(21) Appl. No.: 11/686,987

(22) Filed: Mar. 16, 2007

(51) Int. Cl. G06Q 40/00

(52) U.S. Cl. 705/37

(57) ABSTRACT

According to one embodiment, a system for confirmation data transfer in a distributed trading network includes a memory and an account manager. The memory stores a confirmation address associated with a trading account. The account manager receives a trading order associated with the trading account and sends a confirmation message to the confirmation address, where the confirmation message indicates that the trading order has been received. The account manager receives a manage account request generated in response to the confirmation message, where the manage account request requests performance of a management operation on the trading account, and perform the management operation on the trading account.

### TECHNICAL FIELD

This invention relates generally to the field of distributed data processing systems and more specifically to a system and method for the transfer of confirmation data in a distributed electronic trading system.

### BACKGROUND

In recent years, electronic trading systems have gained widespread acceptance for trading a variety of items, such as goods, services, financial instruments, and commodities. For example, electronic trading systems may be used to trade stocks, fixed income securities, currencies, futures contracts, oil, and gold.

A trading account holds monetary resources that a trader may use to perform trades. Known techniques for managing a trading account involve accessing an account management webpage of the electronic trading system. These known techniques, however, are not efficient in certain situations. It is generally desirable to have efficient techniques for managing a trading account.

### SUMMARY OF THE DISCLOSURE

In accordance with the present invention, disadvantages and problems associated with previous techniques for managing a trading account may be reduced or eliminated.

According to one embodiment, a system for confirmation data transfer in a distributed trading network includes a memory and an account manager. The memory stores a confirmation address associated with a trading account. The account manager receives a trading order associated with the trading account and sends a confirmation message to the confirmation address, where the confirmation message indicates that the trading order has been received. The account manager receives a manage account request generated in response to the confirmation message, where the manage account request requests performance of a management operation on the trading account. The account manager performs the management operation on the trading account.

Certain embodiments of the invention may provide one or more technical advantages. A technical advantage of one embodiment may be that a trading platform sends a confirmation message in response to receiving a trading order. A trader may send a manage account request that is generated in response to the confirmation message. The trader may use the manage account request to request performance of a management operation on the trading account of the trader. Another technical advantage of one embodiment may be that the management operation may perform any suitable operation, such as disabling a trading account.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates one embodiment of a trading system operable to receive and execute trading orders from traders;

FIG. 2 illustrates one embodiment of a confirmation message that may be used with the system of FIG. 1; and

FIG. 3 is a flowchart illustrating one embodiment of a method for performing a management operation on a trading account that may be used with the system of FIG. 1.

### DETAILED DESCRIPTION OF THE DRAWINGS

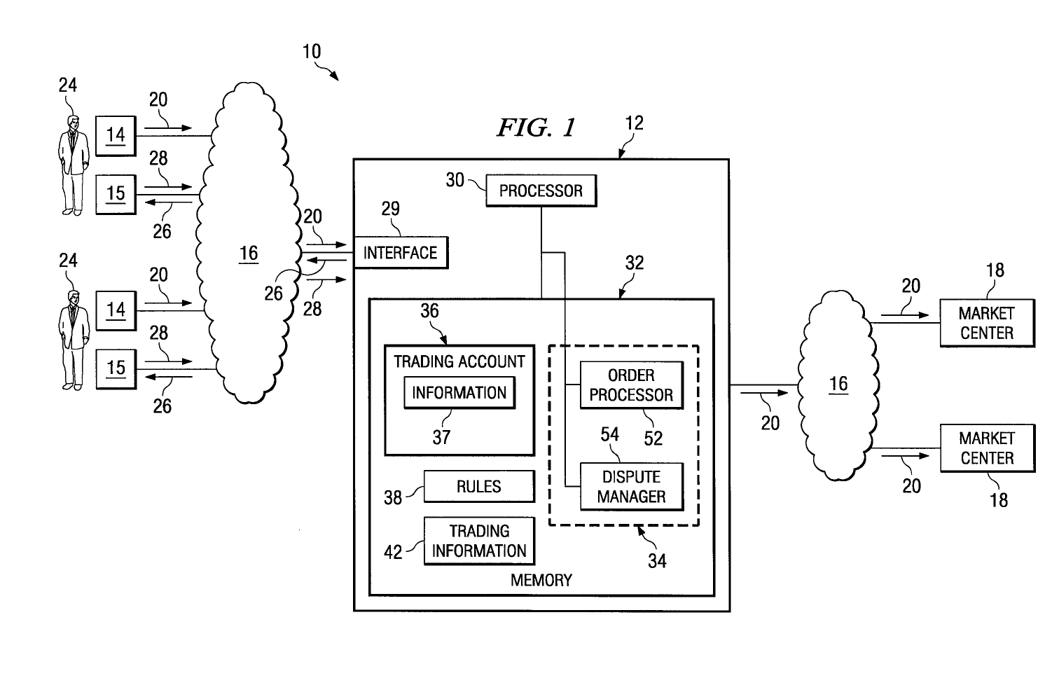

Embodiments of the present invention and its advantages are best understood by referring to FIGS. 1 through 3 of the drawings, like numerals being used for like and corresponding parts of the various drawings.

FIG. 1 illustrates one embodiment of a trading system 10 operable to receive and execute trading orders 20 from traders 24. According to the illustrated embodiment, a trading platform 12 is coupled to one or more client systems 14, one or more client notification devices 15, and one or more market centers 18 via one or more networks 16. In general, a particular trader 24 may be associated with a particular client system 14 and a corresponding client notification device 15.

In one example of operation, trading platform 12 receives a trading order 20 from a client system 14. Trading platform 12 sends a confirmation message 26 to a corresponding client notification device 15 indicating receipt of trading order 20. Upon receipt of confirmation message 26, trader 24 may wish to request performance of a management operation on a trading account 36 of trader 24. For example, an unauthorized entity may have sent trading order 20 from a particular client system 14. Because the unauthorized entity may still be operating client system 14, a confirmation message 26 sent to client system 14 would not appropriately notify trader 24 of this activity. Thus, confirmation message 26 is sent to client notification device 15 which may be separate from client system 14. Upon receiving the confirmation message 26, the trader 24 may realize that the transaction was unauthorized and take the appropriate steps to dispute the transaction, disable trading account 36, or otherwise manage account activity. Trader 24 may send a manage account request 28 to request performance of the chosen management operation.

According to one embodiment, traders 24 may represent users of trading system 10 capable of placing and/or responding to trading orders 20. A trader 24 may represent a principal, an agent acting on behalf of a principal, an individual, a legal entity (such as a corporation), or any machine or mechanism that is capable of placing and/or responding to trading orders 20.

A trading order 20 may represent an order to buy or sell a particular amount of a particular trading product. A trading product may refer to any suitable product or combination of products that forms the basis of a given trading order 20. Examples of trading products may include any type of goods, services, financial instruments, commodities, equities, stocks, fixed income securities, interest rate derivatives, currencies, futures contracts, debentures, options, securities, derivative trading instruments, or any other suitable product or combination of products.

A trading order 20 may include trading order parameters that specify particular values for variables of trading order 20. Examples of trading order parameters may include a quantity of a trading product, a type of trading product, a target price, other parameters describing a trading order 20, or any combination of the preceding. A target price may refer to a target bid price and/or target offer price.

A client system 14 may represent any suitable end-user element that may be used to access one or more elements of trading system 10, such as trading platform 12. Examples of an end-user element include a computer, a workstation, a telephone, an Internet browser, an electronic notebook, a personal digital assistant (PDA), a pager, or any other suitable device (wireless or otherwise) capable of receiving, processing, storing, and/or communicating information with other components of system 10.

A client notification device 15 may represent any suitable end-user element, as described above, to which trading platform sends a confirmation message 26. In one embodiment, a trader 24 may designate a client notification device 15 for trading account 36 of trader 24. Examples of client notification device 15 include a PDA, a separate email account, a mobile phone, or other end-user element.

A network 16 may represent a communication platform operable to exchange information. A communication network may comprise at least a portion of a plain old telephone system (POTS), a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, other suitable communication link, or any combination of the preceding.

Trading platform 12 may represent a trading architecture that facilitates the processing of trading orders 20 and the management of trading accounts 36. Trading platform 12 may be configured at a management center or a headquartering office for any person, business, or entity that seeks to manage the trading of orders 20. Trading platform 12 may include any suitable combination of logic, personnel, devices, or entities that may be utilized to perform the operations of an administrative body or a supervising entity that manages or administers a trading environment.

According to the illustrated embodiment, trading platform 12 may comprise an interface 29, a processor 30, and a memory 32 coupled as shown. Interface 29 may communicate with client systems 14, client notification devices 15, and/or network 16. Processor 30 may execute instructions of applications 34 and manipulate data of memory 32. Processor 30 may comprise any suitable combination of hardware and/or software implemented in one or more modules to provide the described function or operation.

Memory 32 comprises any suitable combination of volatile or non-volatile memory that may store applications 34, one or more trading accounts 36, one or more rules 38, and trading information 42. A trading account 36 holds monetary resources that trader 24 may use to perform trades. For example, trading account 36 may hold stocks, cash, securities, other monetary resources, or any combination of the preceding.

Trading account 36 may include trading account information 37 that describes trading account 36. Account information 37 may include identifiers and/or passcodes associated with trading account 36. Examples of identifiers may include an account identifier identifying trading account 36, a trader identifier (such as a username) identifying trader 24, and/or a device identifier (such as an IP address, email address, telephone number, instant messaging address, short message service (SMS) address, text message address, or the like) identifying devices associated with trader 24. For example, account information 37 may include one or more confirmation addresses that identify client notification devices 15.

Rules 38 may represent rules for processing trading orders 20 and managing trading accounts 36. For example, rules 38 may be used to perform management operations. Examples of management operations are described below.

Trading information 42 may comprise information that describes trading of a trading order 20. For example, trading information 42 may include information about trading order 20, such as trading order parameters.

Applications 34 may include an order processor 52 and an account manager 54. Order processor 52 may process trading orders 20 to determine whether trading orders 20 can be satisfied. A trading order 20 may be satisfied in any suitable manner. As an example, a buy order requesting a specific trading amount at a bid price may be satisfied by a sell order that is able to provide the trading amount (or more) at the bid price (or less). As another example, a sell order offering a specific trading amount at an offer price may be satisfied by a buy order that is requesting the specific trading amount (or less) at the offer price (or more).

Account manager 54 may manage trading accounts 36, and may perform management operations to manage trading accounts 36. A management operation may refer to an operation that may be performed to manage a trading account 36. Any suitable type, number, or combination of operations may be performed.

Market centers 18 comprise all manner of order execution venues including exchanges, Electronic Communication Networks (ECNs), Alternative Trading Systems (ATSs), market makers, or any other suitable market participants. Each market center 18 may maintain a bid and offer price for a given trading product by standing ready, willing, and able to buy or sell that trading product at publicly quoted prices, also referred to as market center prices. Different market centers 18 may provide different market center prices for particular trading products. For example, a particular market center 18 may offer a particular bid price and/or offer price for a particular trading product, while another market center 18 may offer a different bid price and/or offer price for the same trading product. A particular market center 18 may charge a transaction cost to execute trading orders 20 that remain in the order books of that market center 18 for more than a certain length of time.

In one example of operation, trading platform 12 receives a trading order 20 from a client system 14. Trading platform 12 sends a confirmation message 26 to a client notification device 15 indicating receipt of trading order 20. Upon receipt of confirmation message 26, trader 24 may wish to request performance of a management operation on a trading account 36 of trader 24. For example, an unauthorized entity may have sent trading order 20 and, as a result, trader 24 may wish to disable trading account 36. Trader 24 may send a manage account request 28 to request performance of the management operation.

Account manager 54 may perform any suitable type, number, or combination of operations. As an example, a first type of management operation may activate or deactivate a trading account 36. Trading account 36 may be activated to allow a trader 24 to use trading account 36, and may be deactivated to prevent anyone from using trading account 36. For example, an activate account operation may activate trading account 36, and a deactivate account operation may deactivate trading account 36.

As another example, another type of management operation may enable or disable a trading account 36. Trading account 36 may be enabled to allow trading, and may be disabled to suspend trading. For example, an enable account operation may enable trading account 36, and a disable account operation may disable trading account 36.

As yet another example, another type of management operation may change the authorized traders 24 or authorized client notification devices 15 of a trading account 36. User identifiers may be added to or subtracted from a list of authorized traders 24 of trading account 36. Similarly, client system identifiers may be added to or subtracted from a list of authorized client notification devices 15 of trading account 36.

As yet another example, another type of management operation may retrieve information related to a trading account 36. For example, a management operation may retrieve information about the sender of a trading order 20, the status of trading account 36, and/or the recent activity of trading account 36.

As yet another example, another type of management operation may modify information related to a trading account 36. For example, a management operation may change a password, a passcode, and/or user identifier for trading account 36.

As yet another example, another type of management operation may log information related to a trading account 36. For example, a management operation may log operations that were performed when a trading order 20 was received and processed.

As yet another example, another type of management operation may send a notification related to a trading account 36. For example, a management operation may send a notification describing trading activity to predetermined destinations associated with trader 24. The notification may alert the authorities of an unauthorized trading order 20.

As yet another example, another type of management operation may operate on trading orders 20 of a trading account 36. For example, a management operation may cancel, undo, and/or suspend a trading order 20 that initiated the management operation and/or subsequent trading orders 20.

Modifications, additions, or omissions may be made to trading system 10 without departing from the scope of the invention. The components of trading system 10 may be integrated or separated according to particular needs. Moreover, the operations of system 10 may be performed by more, fewer, or other modules. Additionally, operations of trading system 10 may be performed using any suitable logic. System 10 may include components operable to perform the functions and operations of the element, such as logic, an interface, memory, other component, or any suitable combination of the preceding.

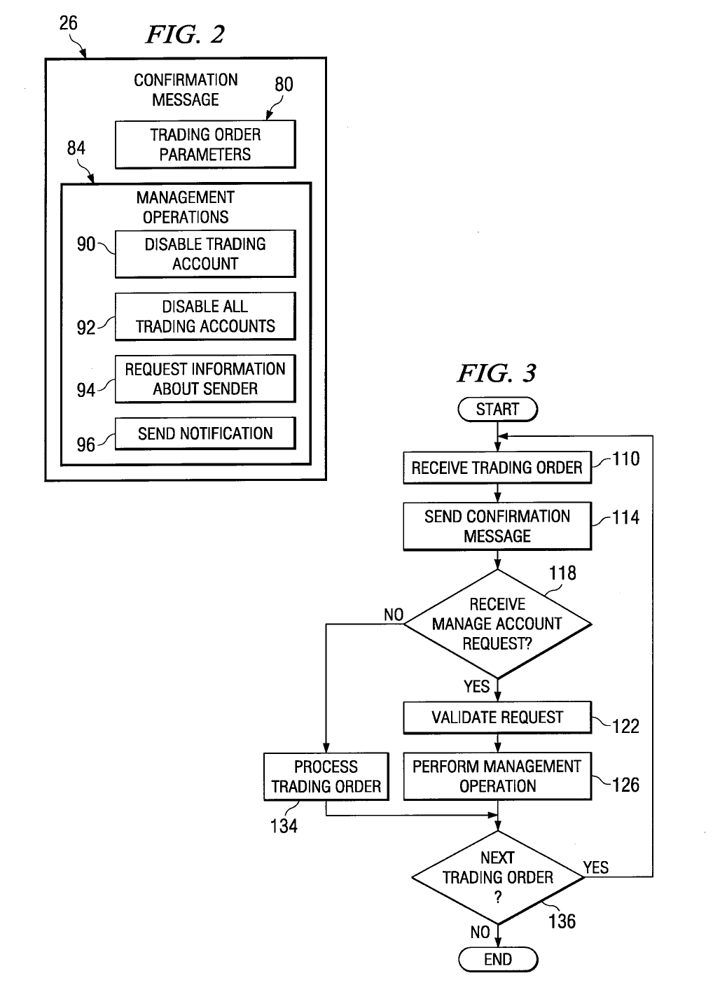

FIG. 2 is a diagram illustrating one embodiment of confirmation message 26 that may be used with system 10. Confirmation message 26 may represent a message that is sent in response to receiving a trading order 20 and that indicates that trading order 20 has been received. In general, a message may have any suitable format, for example, an email message, a text message, telephone message, an SMS message, a web page, a voicemail message, or other suitable message operable to communicate information, or any combination of the preceding.

Confirmation message 26 may be configured such that a manage account request 28 can be generated using confirmation message 26. According to one embodiment, confirmation message 26 may be embodied as an email message, and manage account request 28 may be generated as a reply to the email message. According to another embodiment, confirmation message 26 may be embodied as a webpage with a graphical user interface, and manage account request 28 may be submitted through the graphical user interface.

Confirmation message 26 may include any suitable information and may have any suitable format. According to the illustrated embodiment, confirmation message 26 includes a trading order parameters section 80 and a management operation section 84.

Trading order parameters section 80 may include trading order parameters of the trading order 20. For example, trading order parameters section 80 may display a target offer price, a trading product identifier, and/or a trading order quantity for a given trading order 20.

Management operation section 84 includes management operation buttons. A button may refer to an element, such as a graphical element, that may be selected to initiate an action. Examples of buttons include a graphical button, a check box, a menu item, a selector, or any other suitable element operable to be selected to initiate an action.

A management operation button may be selected by trader 24 to generate “manage account” request 28 requesting performance of a particular management operation. A “disable account” button 90 may be used to disable a trading account 36 associated with trading order 20. A “disable all trading accounts” button 92 may be used to disable all trading accounts 36 of trader 24. A “request information” button 94 may be used to request information about the sender of trading order 20, for example, the source address of trading order 20. A “send notification” button 96 may be used to request that a notification be sent to other destinations, such as to other accounts 36 of trader 24. The management operations described above may have a corresponding button, but only particular ones are illustrated/described herein for sake of brevity.

Modifications, additions, or omissions may be made to confirmation message 26 without departing from the scope of the invention. Confirmation message 26 may include more, fewer, or other fields or values. Additionally, fields or values may be arranged in any suitable manner without departing from the scope of the invention.

FIG. 3 is a flowchart illustrating one embodiment of a method for performing a management operation on a trading account that may be used with system 10 of FIG. 1. The method begins at step 110, where trading platform 12 receives a trading order 20 for a trading account 36 of a trader 24. Order processor 52 sends a confirmation message 26 to client notification device 15 at step 114. Confirmation message 26 indicates that trading platform 12 has received trading order 20.

A manage account request 28 may be received at step 118. Manage account request 28 may request that a management operation be performed on trading account 36. The management operation may comprise, for example, a disable account operation that disables trading account 36.

If a manage account request 28 is received at step 118, the method proceeds to step 122, where account manager 54 validates request 28. Request 28 may be validated by establishing that request 28 was sent by an authorized user. If request 28 is not valid, the requested management operation is not performed, and a notification of the invalid request 28 may be sent to trader 24 via a different confirmation address. Account manager 54 performs the requested management operation at step 126. For example, account manager 54 disables the trading account.

If a manage account request 28 is not received at step 118, the method proceeds to step 134. Order processor 52 processes trading order 20 at step 134. Order processor 52 may process trading order to determine if trading order 20 can be satisfied. The method then proceeds to step 136.

There may be a next trading order 20, at step 136. If there is a next trading order 20, the method returns to step 110 to receive the next trading order 20. If there is no next trading order 20, at step 136, the method terminates.

Modifications, additions, or omissions may be made to the method without departing from the scope of the invention. The method may include more, fewer, or other steps. Additionally, steps may be performed in any suitable order without departing from the scope of the invention.

While this disclosure has been described in terms of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure, as defined by the following claims.

What is claimed is:

1. A system for confirmation data transfer in a distributed trading network, comprising:
a memory operable to store a confirmation address associated with a trading account; and
an account manager coupled to the memory and operable to:
receive a trading order associated with the trading account;
send a confirmation message to the confirmation address in response to receiving the trading order, the confirmation message indicating that the trading order has been received;
receive a manage account request generated in response to the confirmation message, the manage account request requesting performance of a management operation on the trading account; and
perform the management operation on the trading account.

2. The system of claim 1, the account manager further operable to determine whether the trading order can be satisfied.

3. The system of claim 1, the manage account request comprising an electronic mail reply message to the confirmation message.

4. The system of claim 1, the confirmation message comprising a button of a graphical user interface, the button operable to initiate generation of the manage account request in response to being selected.

5. The system of claim 1, the confirmation message comprising a plurality of buttons of a graphical user interface, each button associated with a management operation of a plurality of management operations, each button operable to initiate generation of the manage account request for the associated management operation in response to being selected.

6. The system of claim 1, wherein the management operation is operable to perform at least one of the following:
activate the trading account;
enable the trading account;
change an authorized trader of the trading account;
change an authorized client system of the trading account;
retrieve information related to the trading account;
log information related to the trading account;
modify information related to the trading account;
send a notification related to the trading account;
deactivate the trading account; and
disable the trading account.

7. The system of claim 1, wherein the management operation is operable to perform one of the following on the trading order:
cancel the trading order;
undo the trading order;
suspend the trading order; and
monitor the trading order.

8. The system of claim 1, the account manager further operable to send a management operation response indicating that the management operation has been performed.

9. The system of claim 1, wherein:
the trading order is received from a client system associated with the trading account; and
the confirmation address is associated with a client notification device that is separate from the client system.

10. A method, comprising:
storing a confirmation address associated with a trading account;
receiving a trading order associated with the trading account;
sending a confirmation message to the confirmation address in response to receiving the trading order, the confirmation message indicating that the trading order has been received;
receiving a manage account request generated in response to the confirmation message, the manage account request requesting performance of a management operation on the trading account; and
performing the management operation on the trading account.

11. The method of claim 10, further comprising determining whether the trading order can be satisfied.

12. The method of claim 10, the manage account request comprising an electronic mail reply message to the confirmation message.

13. The method of claim 10, the confirmation message comprising a button of a graphical user interface, the button operable to initiate generation of the manage account request in response to being selected.

14. The method of claim 10, the confirmation message comprising a plurality of buttons of a graphical user interface, each button associated with a management operation of a plurality of management operations, each button operable to initiate generation of the manage account request for the associated management operation in response to being selected.

15. The method of claim 10, wherein the management operation is operable to perform at least one of the following:
activate the trading account;
enable the trading account;
change an authorized trader of the trading account;
change an authorized client system of the trading account;
retrieve information related to the trading account;
log information related to the trading account;
modify information related to the trading account;
send a notification related to the trading account;
deactivate the trading account; and
disable the trading account.

16. The method of claim 10, wherein the management operation of is operable to perform one of the following on the trading order:
cancel the trading order;
undo the trading order;
suspend the trading order; and
monitor the trading order.

17. The method of claim 10, further comprising sending a management operation response indicating that the management operation has been performed.

18. The method of claim 10, wherein:
the trading order is received from a client system associated with the trading account; and
the confirmation address is associated with a client notification device that is separate from the client system.

19. Logic embodied in a computer-readable medium and when executed by a computer operable to:
store a confirmation address associated with a trading account; and
receive a trading order associated with the trading account;
send a confirmation message to the confirmation address in response to receiving the trading order, the confirmation message indicating that the trading order has been received;
receive a manage account request generated in response to the confirmation message, the manage account request requesting performance of a management operation on the trading account; and
perform the management operation on the trading account.

20. The logic of claim 19, further operable to determine whether the trading order can be satisfied.

21. The logic of claim 19, the manage account request comprising an electronic mail reply message to the confirmation message.

22. The logic of claim 19, the confirmation message comprising a button of a graphical user interface, the button operable to initiate generation of the manage account request in response to being selected.

23. The logic of claim 19, the confirmation message comprising a plurality of buttons of a graphical user interface, each button associated with a management operation of a plurality of management operations, each button operable to initiate generation of the manage account request for the associated management operation in response to being selected.

24. The logic of claim 19, wherein the management operation is operable to perform at least one of the following:
activate the trading account;
enable the trading account;
change an authorized trader of the trading account;
change an authorized client system of the trading account;
retrieve information related to the trading account;
log information related to the trading account;
modify information related to the trading account;
send a notification related to the trading account; and
deactivate the trading account; and
disable the trading account.

25. The logic of claim 19, wherein the management operation is operable to perform one of the following on the trading order:
cancel the trading order;
undo the trading order;
suspend the trading order; and
monitor the trading order.

26. The logic of claim 19, further operable to send a management operation response indicating that the management operation has been performed.

27. The logic of claim 19, wherein:
the trading order is received from a client system associated with the trading account; and
the confirmation address is associated with a client notification device that is separate from the client system.

28. A system, comprising:
means for storing a confirmation address associated with a trading account;
means for receiving a trading order associated with the trading account;
means for sending a confirmation message to the confirmation address in response to receiving the trading order, the confirmation message indicating that the trading order has been received;
means for receiving a manage account request generated in response to the confirmation message, the manage account request requesting performance of a management operation on the trading account; and
means for performing the management operation on the trading account.

29. A system, comprising:
a memory operable to store a confirmation address associated with a trading account; and
an account manager coupled to the memory and operable to:
receive a trading order associated with the trading account;
send a confirmation message to the confirmation address in response to receiving the trading order, the confirmation message indicating that the trading order has been received, the confirmation message comprising a plurality of buttons of a graphical user interface, each button associated with a management operation of a plurality of management operations, each button operable to:
initiate generation of a manage account request for the associated management operation in response to being selected;
receive a manage account request generated in response to the confirmation message, the manage account request comprising an electronic mail reply message to the confirmation message, the manage account request requesting performance of a plurality of management operation on the trading account;
perform the management operations on the trading account; and
send a management operation response indicating that the management operation has been performed.
